(19) United States
(12) Patent Application Publication
(10) Pub. No.: US 2025/0163288 A1
(43) Pub. Date: May 22, 2025

(54) DIRECT THERMAL INK WITH SIDE CHAIN CRYSTALLINE MATERIAL FOR LOW ENERGY HEAT SOURCES

(71) Applicant: Temptime Corporation, Morris Plains, NJ (US)

(72) Inventors: Brian S. HUFFMAN, Belle Mead, NJ (US); Marielle K. SMITH, Parlin, NJ (US); Thi N. DO, West Orange, NJ (US)

(73) Assignee: Temptime Corporation, Morris Plains, NJ (US)

(21) Appl. No.: 18/511,936

(22) Filed: Nov. 16, 2023

(51) Int. Cl. C09D 11/50; B41M 5/333; B41M 5/36; C09D 11/037; C09D 11/107

(52) U.S. Cl. CPC C09D 11/50; B41M 5/333; B41M 5/36; C09D 11/037; C09D 11/107

(57) ABSTRACT

Direct thermal inks with side chain crystalline material for low energy heat sources are disclosed herein. An example direct thermal ink with side chain crystalline material for low energy heat source includes a thermal printable media, including: a substrate; and a thermochromic composite, comprising: a color former; a color developer; and a melting agent; wherein the thermochromic composite is coupled to the substrate; and the melting agent comprises a side chain crystalline (SCC) material.

### BACKGROUND

In the field of mobile thermal printing, substandard heat exposure to the direct thermal ink often results in impaired or reduced color development in the final thermal printed product. Substandard heat exposure can result from different darkness settings (thermal printhead heat), imprecise printhead contact, low ambient temperature, inconsistent power delivery, and a host of other complications.

### SUMMARY

In an embodiment, the present disclosure includes a thermally printable media, including: a substrate; and a thermochromic composite, comprising: a color former; a color developer; and a melting agent; wherein the thermochromic composite is coupled to the substrate; and the melting agent comprises a side chain crystalline (SCC) material.

In a variation of this embodiment, the SCC material is a polymer.

In a variation of this embodiment, the polymer is an acrylate.

In a variation of this embodiment, the acrylate is polyalkyl acrylate.

In a variation of this embodiment, the thermochromic composite comprises a leuco dye.

In a variation of this embodiment, thermochromic composite scores in the range of 1.1 to 3.2 on the Thermochromic Melt Index.

In a variation of this embodiment, thermochromic composite scores in the range of 1.3 to 1.7 on the Thermochromic Melt Index.

In a variation of this embodiment, a proportion of the SCC polymer in the thermochromic composite, by weight, is within a range of 25% to 75%.

In a variation of this embodiment, the proportion of the SCC polymer in the thermochromic composite is within a range of 40% to 60%.

In a variation of this embodiment, the proportion of the SCC polymer in the thermochromic composite is within a range of 45% to 55%.

In a variation of this embodiment, the substrate comprises a material selected from group consisting of: paper, paperboard, cardboard, cotton, linen, jute, ramie, industrial hemp or rayon, polyamide, polyester, polyacrylate, polyurethanes or vinyl-based fibers, blended fibrous substrates based on cellulosic and non-cellulosic fibers; polymeric resin; and composites of polymeric resins with cellulosic or non-cellulosic fibrous material; and combinations thereof.

In a variation of this embodiment, the substrate is paper.

In a variation of this embodiment, the average monomer length of the SCC polymer is in a range of two to thirty.

In a variation of this embodiment, the average monomer length of the SCC polymer is in the range of sixteen to eighteen.

In a variation of this embodiment, a peak melt temperature threshold for the thermochromic composite is in a range of about 60 degrees Celsius (C), to about 90 degrees C.

In a variation of this embodiment, a peak melting temperature threshold for the thermochromic composite is in a range of 74 degrees C. to 82 degrees C.

In a variation of this embodiment, the thermal printable media is disposed in a roll, about a spool, or in a fan fold stack.

In a variation of this embodiment, the substrate further comprises an adhesive backing and is temporarily adhered to a backing layer by the adhesive backing.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed devices, methods and apparatuses, and explain various principles and advantages of those embodiments.

FIG. 1 illustrates a thermal printable media, configured as a sheet, according to embodiments of the present disclosure.

FIG. 2 illustrates a thermal printable media, configured as a roll, according to embodiments of the present disclosure.

FIG. 3 illustrates a thermal printable media, configured as a roll of a web of thermally printable adhesive labels, according to embodiments of the present disclosure.

FIG. 4A illustrates results of Experiment 1, according to embodiments of the present disclosure.

FIG. 4B illustrates results of Experiment 2, according to embodiments of the present disclosure.

FIG. 4C illustrates results of Experiment 2, according to embodiments of the present disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

The apparatus and method components have been represented where appropriate by conventional symbols in the drawings, showing only those specific details that are pertinent to understanding the embodiments of the present disclosure so as not to obscure the description with details that will be readily apparent to those of ordinary skill in the art having the benefit of the description herein.

### DETAILED DESCRIPTION

The present disclosure describes a thermochromic composite, e.g. a thermal ink composition, including a side chain crystalline (SCC) material. Typical thermal inks, such as leuco dyes, include three functional components: a color developer, a color former and a melting agent. Thermochromic inks, prior to exposure to an applied heat, generally exist in a solid phase. The melting agent acts as a matrix in which the color former and color developer are contained when the leuco dye is in the solid phase. When exposed to an applied heat, such as during a thermal printing process, the melting agent melts and transitions to a liquid phase which releases the color former and color developer from the matrix, facilitating the combination of the color developer and the color former. In the liquid phase, the color former and color developer are no longer immovably separated, and thus enabled to chemically react. The resulting reaction between the color former and color developer induces a color state change which is perceived by an observer as the development of the ink.

The thermochromic composite of the present disclosure introduces a SCC material as a secondary and compatible melting agent to a leuco dye. In some examples the SCC material may replace the melting agent in the thermochromic composite, and in other examples the SCC material may be added to a leuco dye containing a non-SCC melting agent, e.g. a wax. The SCC material has a desirable benefit of sharp melting points, as well as a hysteresis between the melting point and the solidification point. The addition of the SCC material to a typical thermal ink allows for a more rapid melt onset, allowing color development to occur in response to a shorter period of heat exposure. The hysteresis between the melting point and solidification point of the SCC allows color development to continue once the temperature of the composition has fallen below the melting point of the composite after the conclusion of heat exposure. Furthermore, the SCC solidifies having a reduced opacity (increased transparency) relative to the solid SCC before melt onset. This aspect allows the print media to be viewed more clearly after development.

In some embodiments, the SCC material is a synthetic polymer material, such as an acrylate, and in some examples, the SCC material is polyalkyl acrylate.

The SCC material is variably configurable such that the thermochromic composite can be tuned melt, and thus to develop color, at different temperatures, allowing for compatibility with a plurality of printers and print settings, ideally without suffering decreases in print quality.

The melting point of the SCC material, and thus the melting point of the thermochromic composite, can be adjusted by increasing the length of the monomer chains, also referred to as the “side-chain length,” within the SCC material. In some examples the average monomer length in the SCC material is about 2, about 4, about 6, about 8 or about 10. In other examples the average monomer length in the SCC material is about 12, about 14, about 16, about 18 or about 20. In other examples the average monomer length in the SCC material is about 22, about 24, about 26, about 28 or about 30. The adjustable melting point of the thermochromic composite allows for formulations of the thermochromic composite which are able to deliver comparable color development for suboptimal printing conditions.

In some examples, a thermochromic composite with a melting point of 74 degrees C. (˜15 degrees C. lower than a leuco dye alone) may be employed in suboptimal conditions, such as substantially lower ambient temperatures, without sacrificing print quality or compensatory printer setting adjustment. Other suboptimal conditions include situations in which power delivery to a printer is impaired or otherwise below specifications, situations in which a thermal printhead is impaired, or otherwise failing to deliver sufficient heat flux, and wherein the temperature of a feed source of the thermal printable media on which the thermochromic composite is disposed is substantially lower than ideally specified.

Furthermore, in some embodiments, the thermochromic composite with the SCC material may be employed towards power saving applications, by reducing the necessary power consumption of a thermal printer in order to achieve a baseline print quality. By reducing the melt temperature of the thermochromic composite, the heat input from the thermal printer required to achieve a predetermined print quality can also be reduced, which in turn reduces power consumption on a per print basis, thus reducing electricity costs for the user.

According to some embodiments, the hysteretic properties of the thermochromic composite with SCC material can also provide power consumption reduction benefits. When the thermochromic composite cool to the solidification point, the structural matrix is reformed by the melting agent, and further development between the color developer and color former is stalled. In leuco dyes alone, the solidification point is often closely proximate to the melting point. The hysteretic effect of the SCC material may lower the solidification point substantially below the melting point of the thermochromic composite, such that even after cooling to the melting point, the thermochromic composite continues to develop color for a longer period of time than the leuco dye alone.

An additional benefit of incorporating the SCC material in the thermochromic composite is that the concentration of leuco dye in the composite can be considerably reduced without sacrificing print quality, resulting in a cost effective and environmentally friendly result. The effectiveness of the SCC material as a melting agent is such that, in the liquid phase, the relatively low viscosity of the thermochromic composite facilitates rapid movement of color former and color developer molecules within the composite, allowing for more molecular collisions and more reactivity, resulting in more rapid and effective color state change. In some examples the proportion (by weight) of the SCC material in the thermochromic composite may be about 25%, about 30%, about 35%, about 40%, about 45%, about 50%, about 55%, about 60%, about 65%, about 70%, or about 75%.

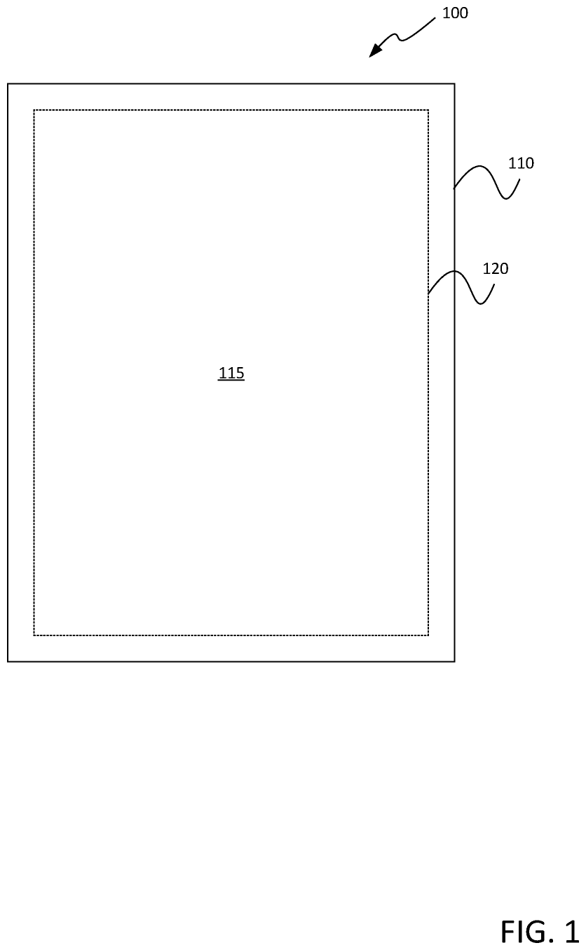

FIG. 1 illustrates a sheet 100 of thermally printable material, including a substrate 110 and thermochromic composite 115 (e.g. any of the thermochromic composites described herein) disposed in a printable region 120. In some examples, the substrate 110 is a paper product, such as paper, paperboard, cardboard, cotton, linen, jute, ramie, industrial hemp or rayon, polyamide, polyester, polyacrylate, polyurethanes or vinyl-based fibers, blended fibrous substrates based on cellulosic and non-cellulosic fibers; polymeric resin; and composites of polymeric resins with cellulosic or non-cellulosic fibrous material; and combinations thereof. The thermally printable region 120 is an area of the substrate 110 to which the thermochromic composite 115 has been coupled. In various embodiments, the thermochromic composite 115 may be, via various methods, imbued into a fibrous matrix of the substrate 110. In other examples, the thermochromic composite 115 may be disposed in a coating layer on a surface of the substrate 110.

The thermochromic composite 115 is distributed in sufficient volume across substrate 110 to effectively react and exhibit a readily observable color state change when exposed to an applied heat, e.g. a thermal printing process.

The illustrated embodiment of FIG. 1 shows a thermally printable sheet 100 having dimensional ratios consentient with a letter size sheet; however the present disclosure contemplates embodiments in which the thermal printable media includes any side length ratio. Further contemplated by the present disclosure are embodiments in which the printable region 120 of the sheet 100 occupies the entirety of the surface of substrate 110, asymmetric portions of substrate 110, and any configurations of non-printable margins on sheet 100, as well as embodiments where both faces of the substrate 110 include a printable region 120.

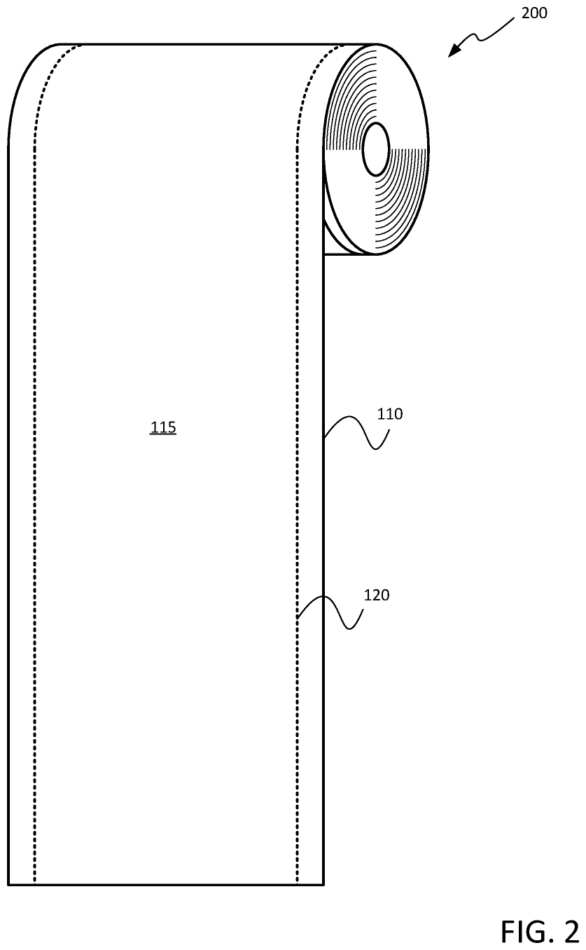

FIG. 2 illustrates a roll 200 of thermally printable material, including a substrate 110 and a thermochromic composite 115 disposed in a printable region 120. The roll 200 is configure as a continuous strip of substrate 110 wound about a spool. According to some embodiments, the roll 200 of thermally printable material is suited for applications with thermal roll printers, for printing media such as receipts, tickets, and other forms of media of constant width and variable length. Although illustrated as having non-printable margins, this disclosure contemplates embodiments where the printable region 120 extends to the edge of the substrate 110, as well as embodiments where both faces of the substrate 110 include a printable region 120.

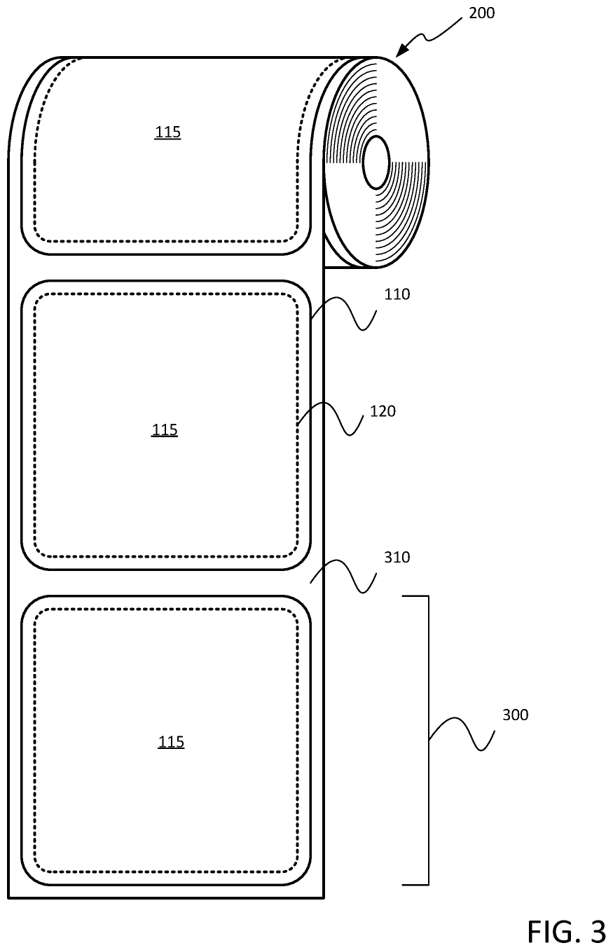

FIG. 3 illustrates a roll 200 of thermally printable labels 300, including a substrate 110, thermochromic composite 115 disposed in printable regions 120, and a liner 310. The roll 200 of thermally printable labels 300 is configured as a web of labels 300, temporarily adhered to a liner 310, which, in some examples, includes a release surface such that the labels 300 may be readily removed for application to a host product. According to some embodiments, the labels 300 include an adhesive backing on the surface of the substrate 110 opposite the printable region 120, by which the labels are temporarily adhered to the liner, and then to the host product. Although illustrated as having non-printable margins, this disclosure contemplates embodiments wherein the printable region 120 of each label 300 extends to the edges of the substrate 110. Embodiments wherein the web of labels is configured as a fan fold stack are further included in the scope of the instant disclosure.

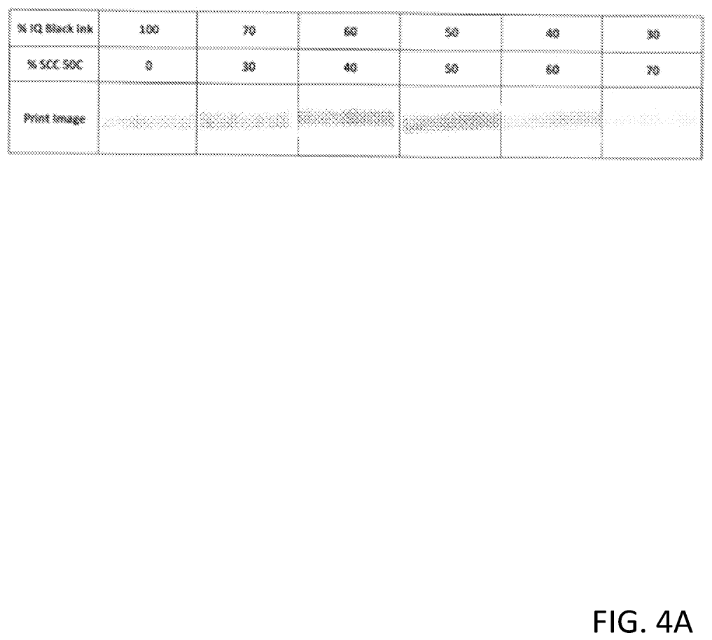

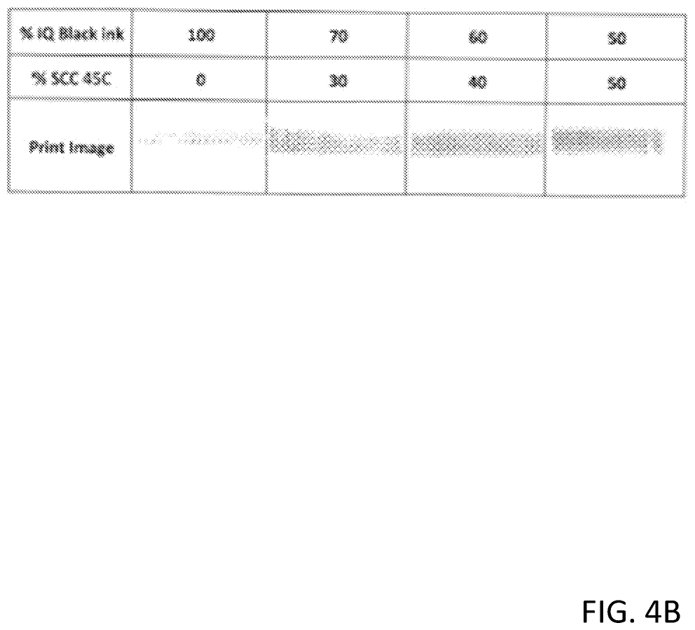

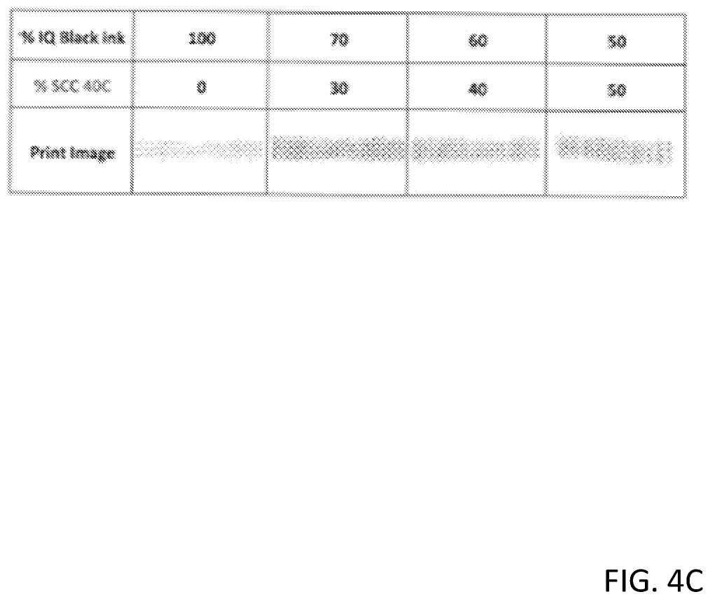

FIG. 4A illustrates experimental results according to Experiment 1, discussion of which may be found in the Examples section below.

FIG. 4B illustrates experimental results according to Experiment 2, discussion of which may be found in the Examples section below.

FIG. 4C illustrates experimental results according to Experiment 3, discussion of which may be found in the Examples section below.

Using the data collected in Experiments 1-3 (see Examples section below), a Thermochromic Melt Index is defined herein. The Thermochromic Melt Index is used to measure the change in melt peak temperature of a thermal ink when combined with an additive. The index is defined as:

$$I = {( \frac{B}{T} )}^{4}$$

Wherein I represents the index score of a sample, B is the temperature in degrees C. of the melt peak of the thermal ink with no additive, and Tis the temperature in degrees C. of the melt peak of the thermochromic composite (e.g. thermal ink with the additive). The ratio of B/T is configured such that reducing the melt temperature results in a higher score, and increasing the melt temperature results in a lower score. The ratio of B/T is raised to the fourth power as a scaling factor to improve readability of the scores. By definition, the score of a thermal ink without an additive is 1.

According to some embodiments, the various embodiments of the thermochromic composite score in the range of 1.1 to 3.2 on the Thermochromic Melt Index.

### EXAMPLES

### Example 1

### Experimental Details

An experiment was performed to find the melt peak temperature (in degrees C.) of various thermochromic composites including a leuco dye and an SCC material in various ratios. Experiment 1 uses 50C SCC 1216-76 (SCC 50C), which is an SCC material, blended with Zebra Thermal Ink IQ Black, (IQ Black Ink), which is a leuco dye based ink. Samples were prepared by manually combining SCC 50C and IQ Black Ink in ratios spanning from 30% SCC 50C by weight to 70% SCC 50C by weight. A 1 gram portion of each sample was air dried in an aluminum weighting dish. A TA Differential Scanning calorimeter was used to measure the melt temperature of the dried ink. A Meyer rod DIV18 was used to coat the ink on Fasson Primax 250 (polypropylene film). The coating was air dried for 24 hours. The dried samples were depressurized for 5 seconds by using JORESTECH Vacuum Packaging Machine Model VAC-275T and sealed with low heat for 0.6 sec. Images were taken after each coated sample was heated, and are included in FIG. 4A.

### Results

TABLE 1
Melt Peaks of various ratios of a thermochromic
composite with SCC 50 C.

| % SCC | % IQ Black | Melt Peak |
|---|---|---|
| 50 C. | Ink | (Degrees C.) |
| 0 | 100 | 89.0 |
| 30 | 70 | 81.0 |
| 40 | 60 | 79.5 |
| 50 | 50 | 77.2 |
| 60 | 40 | 74.0 |
| 70 | 30 | 66.6 |

Table 1 shows that the thermochromic composite with 70% SCC 50C has the lowest melting point, reducing the melt peak by 22.4 degrees C. Examination of the ink development results, shown in FIG. 4A, indicate that the thermochromic composite with 50% SCC 50C had the best development quality.

### Example 2

### Experiment Details

An experiment was performed to find the melt peak temperature (in degrees C.) of various thermochromic composites including a leuco dye and an SCC material in various ratios. Experiment 1 uses 45C SCC 1263-45 (SCC 45C), which is an SCC material, blended with Zebra Thermal Ink IQ Black, (IQ Black Ink), which is a leuco dye based ink. Samples were prepared by manually combining SCC 45C and IQ Black Ink in ratios spanning from 30% SCC 45C by weight to 50% SCC 45C by weight. A 1 gram portion of each sample was air dried in an aluminum weighting dish. A TA Differential Scanning calorimeter was used to measure the melt temperature of the dried ink. A Meyer rod DIV18 was used to coat the ink on Fasson Primax 250 (polypropylene film). The coating was air dried for 24 hours. The dried samples were depressurized for 5 seconds by using JORESTECH Vacuum Packaging Machine Model VAC-275T and sealed with low heat for 0.6 sec. Images were taken after each coated sample was heated, and are included in FIG. 4B.

### Results

TABLE 2
Melt Peaks of various ratios of a thermochromic
composite with SCC 45 C.

| % SCC | % IQ Black | Melt Peak |
|---|---|---|
| 45 C. | Ink | (Degrees C.) |
| 0 | 100 | 89.0 |
| 30 | 70 | 81.2 |
| 40 | 60 | 80.0 |
| 50 | 50 | 79.0 |

Table 2 shows that the thermochromic composite with 50% SCC 45C has the lowest melting point, reducing the melt peak by 10.0 degrees C. Examination of the ink development results of Experiment 2, shown in FIG. 4B, indicate that the thermochromic composite with 50% SCC 45C had the best development quality.

### Example 3

### Experiment Details

An experiment was performed to find the melt peak temperature (in degrees C.) of various thermochromic composites including a leuco dye and an SCC material in various ratios. Experiment 1 uses 40C SCC 1263-15 (SCC 40C), which is an SCC material, blended with Zebra Thermal Ink IQ Black, (IQ Black Ink), which is a leuco dye based ink. Samples were prepared by manually combining SCC 40C and IQ Black Ink in ratios spanning from 30% SCC 40C by weight to 50% SCC 40C by weight. A 1 gram portion of each sample was air dried in an aluminum weighting dish. A TA Differential Scanning calorimeter was used to measure the melt temperature of the dried ink. A Meyer rod DIV18 was used to coat the ink on Fasson Primax 250 (polypropylene film). The coating was air dried for 24 hours. The dried samples were depressurized for 5 seconds by using JORESTECH Vacuum Packaging Machine Model VAC-275T and sealed with low heat for 0.6 sec. Images were taken after each coated sample was heated, and are included in FIG. 4C.

### Results

TABLE 3
Melt Peaks of various ratios of a thermochromic
composite with SCC 40 C.

| % SCC | % IQ Black | Melt Peak |
|---|---|---|
| 40 C. | Ink | (Degrees C.) |
| 0 | 100 | 89.0 |
| 30 | 70 | 81.4 |
| 40 | 60 | 83.0 |
| 50 | 50 | 82.0 |

Table 3 shows that the thermochromic composite with 50% SCC 40C has the lowest melting point, reducing the melt peak by 7.0 degrees C. Examination of the ink development results of Experiment 3, shown in FIG. 4C, indicate that the thermochromic composite with 50% SCC 40C had the best development quality.

Based on the Data from Experiments 1-3, it can be concluded that the SCC acts as a secondary melting agent, solubilizes the IQ Black Ink and lowers the overall melt temperature of the thermal IQ black ink. These factors result in a better quality image having increased color density after exposure to heat. As shown in FIGS. 4A-4C, the print quality improves with increasing concentration of SCC polymer. The best thermal imaging appears to occur when the IQ Black Ink concentration is reduced by 50% and supplemented with 50% SCC (SCC 50C, SCC 45C, or SCC 40C). This results in an environmentally friendly solution. In addition, SCC coatings transition from opaque white to transparent clear after melt and after re-solidified, which further enhances imaging. This phenomenon is not the case with other melting agents that would remain opaque after solidification.

In the foregoing specification, specific embodiments have been described. However, one of ordinary skill in the art appreciates that various modifications and changes can be made without departing from the scope of the disclosure as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed devices, methods and apparatuses are defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

1. A thermal printable media, comprising:
a substrate; and
a thermochromic composite coupled to the substrate, comprising:
a color former;
a color developer; and
a melting agent forming a solid-phase matrix in which the color former and color developer are embedded,
wherein the melting agent is configured to liquefy responsive to an exposure to an applied heat from a thermal printer, releasing the color former and color developer and facilitating a color state change from reaction of the color former and the color developer,
and
wherein the melting agent comprises a side chain crystalline (SCC) material which lowers the peak melt temperature of the thermochromic composite.

2. The thermal printable media of claim 1, wherein the SCC material is a polymer.

3. The thermal printable media of claim 2, wherein the polymer is an acrylate.

4. The thermal printable media of claim 3, wherein the acrylate is polyalkyl acrylate.

5. The thermal printable media of claim 1, wherein the color former and the color developer are provided in the thermochromic composite in the form of a leuco dye.

6. The thermal printable media of claim 1, wherein on the Thermochromic Melt Index, the thermochromic composite scores in a range of 1.1 to 3.2

7. The thermal printable media of claim 1, wherein on the Thermochromic Melt Index, the thermochromic composite scores in a range of 1.3 to 1.7.

8. The thermal printable media of claim 1, wherein a proportion of the SCC material in the thermochromic composite, by weight, is within a range of 25% to 75%.

9. The thermal printable media of claim 1, wherein a proportion of the SCC material in the thermochromic composite is within a range of 40% to 60%.

10. The thermal printable media of claim 1, wherein a proportion of the SCC polymer in the thermochromic composite is within a range of 45% to 55%.

11. The thermal printable media of claim 1, wherein the substrate comprises a material selected from a group consisting of: paper, paperboard, cardboard, cotton, linen, jute, ramie, industrial hemp or rayon, polyamide, polyester, polyacrylate, polyurethanes or vinyl-based fibers, blended fibrous substrates based on cellulosic and non-cellulosic fibers; polymeric resin; and composites of polymeric resins with cellulosic or non-cellulosic fibrous material; and combinations thereof.

12. The thermal printable media of claim 1, wherein the substrate is paper.

13. The thermal printable media of claim 1, wherein an average monomer length of the SCC polymer is in a range of two to thirty.

14. The thermal printable media of claim 1, wherein an average monomer length of the SCC polymer is in a range of sixteen to eighteen.

15. The thermal printable media of claim 1, wherein a peak melt temperature for the thermochromic composite is in a range of about 60 degrees C., to about 90 degrees C.

16. The thermal printable media of claim 1, wherein a peak melt temperature for the thermochromic composite is in a range of 74 degrees C. to 82 degrees C.

17. The thermal printable media of claim 1, wherein the thermal printable media is disposed in a roll, about a spool, or in a fan fold stack.

18. The thermal printable media of claim 1, wherein the substrate further comprises an adhesive backing and is temporarily adhered to a liner by the adhesive backing.

19. A thermochromic composite, comprising:
a color former;
a color developer; and
a melting agent configured to form a solid-phase matrix in which the color former and color developer are embedded, and to liquefy responsive to an exposure to an applied heat from a thermal printer, releasing the color former and color developer and facilitating a color state change from reaction of the color former and the color developer;
wherein the melting agent comprises a side chain crystalline (SCC) material which lowers the peak melt temperature of the thermochromic composite.

20. The thermochromic composite of claim 19, wherein the SCC material is a polyalkyl acrylate polymer.

21. The thermochromic composite of claim 19, wherein the color former and color developer are provided in the thermochromic composite in the form of a leuco dye.
